(19) United States
(12) Patent Application Publication
(10) Pub. No.: US 2026/0025265 A1
(43) Pub. Date: Jan. 22, 2026

(54) SYSTEMS, METHODS, AND DEVICES FOR COMBINING QUANTUM AND CLASSICAL COMMUNICATION CHANNELS USING OPTICAL TECHNOLOGIES

(71) Applicant: JPMORGAN CHASE BANK, N.A., New York, NY (US)

(72) Inventors: Obada ALIA, Bristol (GB); Albert HUANG, Singapore (SG); Marco PISTOIA, Amawalk, NY (US); Ci Wen LIM, Singapore (SG)

(21) Appl. No.: 18/775,524

(22) Filed: Jul. 17, 2024

(51) Int. Cl. H04L 9/08

(52) U.S. Cl. CPC H04L 9/0855; H04L 9/0819

(57) ABSTRACT

A system may include: a first electronic device that receives service classical data and key management system classical data from a first quantum layer, and classical data from a classical data layer, a first multiplexer/demultiplexer that multiplexes the service classical data, the key management system classical data, and the classical data into multiplexed classical data, and the first circulator receives the multiplexed classical data at a first port and routes the multiplexed classical data to a fiber optic channel via a second port. A second circulator at a second electronic device receives the multiplexed classical data from the fiber optic channel on a second port, and routes the multiplexed classical data to the second multiplexer/demultiplexer on a third port, and a second multiplexer/demultiplexer demultiplexes and outputs the service classical data, the key management system classical data, and the classical data.

### BACKGROUND OF THE INVENTION

### 1. Field of the Invention

Embodiments relate to systems, methods, and devices for combining quantum and classical communication channels using optical technologies.

### 2. Description of the Related Art

Quantum communication channels, such as optical fibers, are used to communicate quantum data. Quantum communications, however, often use a low power, making it difficult to use the same fiber to communicate both quantum data and classical data. Because of this, quantum communication channels and classical communication channels each have their own fibers, which increases deployment complexity and cost.

U.S. Patent Publication No. 2020/0376905, the disclosure of which is incorporated, by reference, in its entirety, discloses combined quantum key distribution and classical communication over a pair of optical fibers.

### SUMMARY OF THE INVENTION

Systems, methods, and devices for combining quantum and classical communication channels using optical technologies are disclosed. In one embodiment, a system may include: a first electronic device that may include a first multiplexer/demultiplexer and a first circulator, wherein the first electronic device receives service classical data from a first service device in a first quantum layer, key management system classical data from a first key management system device in the first quantum layer, and classical data from a classical data layer, the first multiplexer/demultiplexer multiplexes the service classical data, the key management system classical data, and the classical data into multiplexed classical data onto a common transmission channel, and the first circulator receives the multiplexed classical data from the common transmission channel at a first port and routes the multiplexed classical data to a fiber optic channel via a second port; and a second electronic device that may include a second multiplexer/demultiplexer and a second circulator, wherein the second circulator receives the multiplexed classical data from the fiber optic channel on a second port, and routes the multiplexed classical data to the second multiplexer/demultiplexer on a third port, and the second multiplexer/demultiplexer demultiplexes the multiplexed classical data into the service classical data, the key management system classical data, and the classical data, and outputs the service classical data, the key management system classical data, and the classical data to a second quantum layer.

In one embodiment, the system may also include a quantum channel that receives quantum key distribution data from the first quantum layer and communicates the quantum key distribution data to the second quantum layer.

In one embodiment, the system may also include an optical attenuator that receives the multiplexed classical data, attenuates the multiplexed classical data, and outputs the attenuated multiplexed classical data to the first circulator, wherein the optical attenuator reduces an aggregated power of the multiplexed classical data.

In one embodiment, the system may also include an amplifier that receives the attenuated multiplexed classical data from the second circulator, amplifies the attenuated multiplexed classical data, and outputs the amplified multiplexed classical data to the second multiplexer/demultiplexer, wherein the amplifier increases the aggregated power of the multiplexed classical data.

In one embodiment, the amplifier may include an Erbium-doped fiber amplifier.

In one embodiment, the system may also include a first filter and a second filter, the first filter receiving the attenuated multiplexed classical data and quantum key distribution data from the first quantum layer and passing the attenuated multiplexed classical data and the quantum key distribution data, and the second filter receiving the attenuated multiplexed classical data and the quantum key distribution data, filtering the quantum key distribution data, passing the filtered quantum key distribution data to the second quantum layer, and outputting the attenuated multiplexed classical data to the second circulator.

In one embodiment, wherein the first filter and the second filter may be centered on a frequency of a quantum channel.

According to another embodiment, a method may include: (1) receiving, at a first multiplexer/demultiplexer of a first electronic device, service classical data from a first quantum key distribution device service channel, key management system classical data from a first key management system, and classical data from a classical data layer in a first quantum layer; (2) multiplexing, by the first multiplexer/demultiplexer, the service classical data, the key management system classical data, and the classical data into multiplexed classical data on a common transmission channel; (3) receiving, by a first circulator, the multiplexed classical data from the common transmission channel at a first port of the first circulator; (4) routing, by the first circulator, the multiplexed classical data to a fiber optic channel via a second port of the first circulator; (5) receiving, by a second circulator, the multiplexed classical data from the fiber optic channel on a second port of the second circulator; (6) routing, by the second circulator, the multiplexed classical data to a third port of the second circulator; (7) receiving, by a second multiplexer/demultiplexer of a second electronic device, the multiplexed classical data from the third port of the second circulator and demultiplexing the multiplexed classical data into the service classical data, the key management system classical data, and the classical data; and (8) outputting, by the second multiplexer/demultiplexer, the service classical data, the key management system classical data, and the classical data to a second quantum layer.

In one embodiment, the method may also include: receiving, on a quantum channel that receives quantum key distribution data from the first quantum layer; and communicating, and communicates the quantum key distribution data to the second quantum layer.

In one embodiment, the method may also include: receiving, by an optical attenuator, the multiplexed classical data from the first multiplexer/demultiplexer; attenuating, by the optical attenuator, the multiplexed classical data, wherein the optical attenuator reduces an aggregated power of the multiplexed classical data; and outputting, by the optical attenuator, the attenuated multiplexed classical data to the first port of the first circulator.

In one embodiment, the method may also include: receiving, by an amplifier, the attenuated multiplexed classical data from the third port of the second circulator; amplifying, by the amplifier, the attenuated multiplexed classical data, wherein the amplifier increases the aggregated power of the multiplexed classical data; and outputting, by the amplifier, the amplified multiplexed classical data to the second multiplexer/demultiplexer.

In one embodiment, the amplifier may include an Erbium-doped fiber amplifier.

In one embodiment, the method may also include: receiving, at a first filter, the attenuated multiplexed classical data and quantum key distribution data from the first quantum layer; passing, by the first filter, the attenuated multiplexed classical data and the quantum key distribution data to a second filter; receiving, by the second filter, the attenuated multiplexed classical data and the quantum key distribution data; filtering, by the second filter, the quantum key distribution data; passing, by the second filter, the filtered quantum key distribution data to the second quantum layer; and outputting, by the second filter, the attenuated multiplexed classical data to the second circulator.

In one embodiment, the first filter and the second filter may be centered on a frequency of a quantum channel.

According to another embodiment, an electronic device may include: a transmitting input interface that may be configured to receive service classical data from a first quantum key distribution device service channel, key management system classical data from a first key management system, and classical data from a classical data layer in a first quantum layer; a multiplexer/demultiplexer that may be configured to multiplex the service classical data, the key management system classical data, and the classical data into multiplexed classical data on a common transmission channel; a circulator that may be configured to receive the multiplexed classical data from the common transmission channel at a first port of the circulator and output the multiplexed classical data on a second port of the circulator; and an output interface that may be configured to output the multiplexed classical data to a transmitting output interface.

In one embodiment, the electronic device may also include: a receiving input interface that may be configured to receive multiplexed classical data and to route the multiplexed classical data to the second port of the circulator; and a receiving output interface that may be configured to receive demultiplexed classical data from the multiplexer/demultiplexer and to output the demultiplexed classical data.

In one embodiment, the electronic device may also include: an optical attenuator that may be configured to receive the multiplexed classical data and to attenuate the multiplexed classical data and outputs the attenuated multiplexed classical data to the circulator, wherein the optical attenuator reduces an aggregated power of the multiplexed classical data.

In one embodiment, the electronic device may also include: an amplifier that may be configured to receive the attenuated multiplexed classical data from a second circulator, to amplify the attenuated multiplexed classical data, wherein the amplifier increases the aggregated power of the multiplexed classical data, and to output the amplified multiplexed classical data to a second multiplexer/demultiplexer.

In one embodiment, the electronic device may also include: a filter that may be configured to receive the attenuated multiplexed classical data and quantum key distribution data from the first quantum layer and to pass the attenuated multiplexed classical data and the quantum key distribution data to the receiving output interface. In one embodiment, the filter may be further configured to receive multiplexed classical data and the quantum key distribution data, to filter the quantum key distribution data, to pass the filtered quantum key distribution data, and to output the attenuated multiplexed classical data to a second circulator.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for combining classical communication channels using optical technologies according to an embodiment;

FIG. 2 illustrates a system for combining quantum and classical communication channels using optical technologies according to an embodiment;

FIG. 3 illustrates an exemplary system for combining quantum and classical communication channels using optical technologies according to an embodiment; and

FIG. 4 illustrates an exemplary system for combining quantum and classical communication channels using optical technologies according to another embodiment.

### DETAILED DESCRIPTION OF PREFERRED EMBODIMENTS

Embodiments relate to systems, methods, and devices for combining quantum and classical communication channels using optical technologies. For example, embodiments allow for bi-directional coexistence of a quantum and classical channels in a single fiber.

Embodiments reduce the number of optical fibers required by combining the quantum and classical channels into single fiber, therefore, reducing operating expenses.

In one embodiment, a passive system that does not use amplification is disclosed. In another embodiment, an active system that uses amplification to boost the power of the classical communication channels is disclosed.

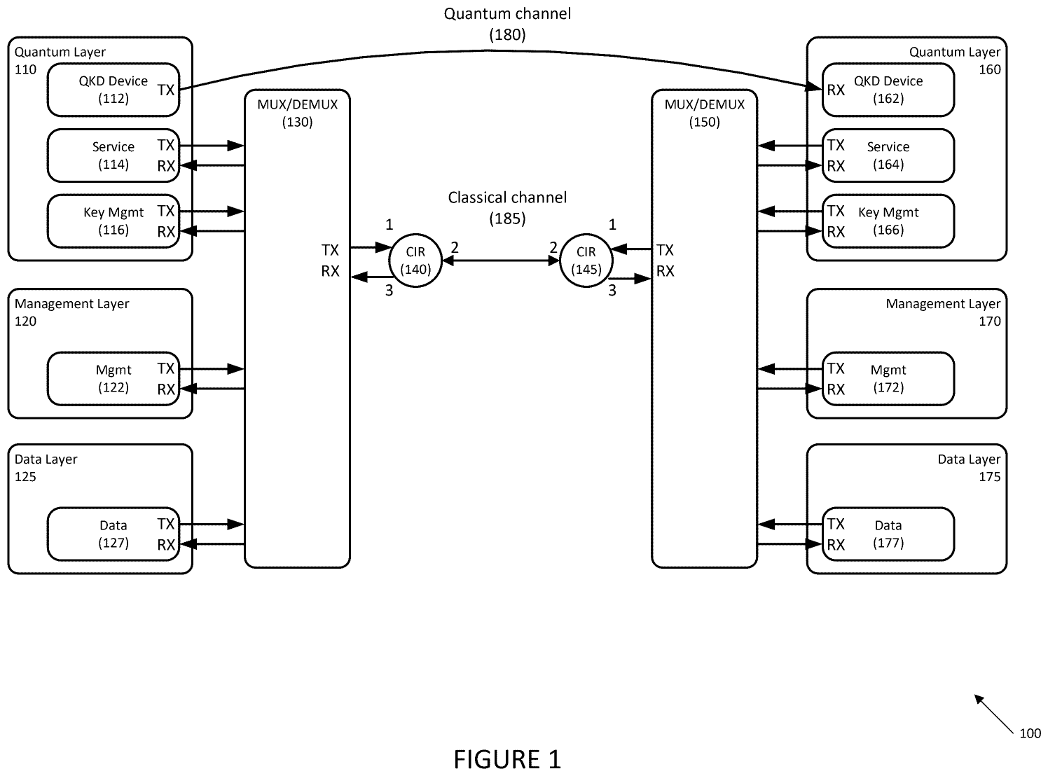

Referring to FIG. 1, a system for combining classical communication channels using optical technologies is disclosed according to an embodiment. System 100 may include quantum layer 110, which may include quantum hardware such as quantum key distribution (QKD) device 112, service device 114, and key management system device 116. Quantum key distribution device 112 communicates quantum data, such as quantum keys, whereas service device 114 and key management system device 116 communicate classical data, such as service classical data and key management system classical data, respectively.

In one embodiment, key management system device 116 may be provided as function of the quantum key distribution device 112, or it may be software based, or may be hardware based in a hardware secure module.

Quantum key distribution device 112 may transmit quantum data to quantum key distribution device 162 on quantum layer 160 over quantum communication channel, such as a dedicated fiber.

Service device 114 may provide data for a service channel for quantum key distribution device 112, and may transmit and receive service classical data that may be used to synchronize clocks. It may also transmit post processing and metadata.

Key management system device 116 may provide data for a KMS channel for quantum layer 110, and may send KMS information related to keys. KMS information may include, for example, key synchronization information, key storage information, key identification, and other key metrics as is necessary and/or desired.

For example, the connections between these devices may be optical fibers.

Management layer 120 may include management device 122. Management device may be is used in the out-of-band management network to access, troubleshoot, and monitor the devices.

Data layer 125 may be a source or destination for classical data 127. In one embodiment, classical data 127 from data layer 125 may be encrypted using, for example, QKD-generated symmetric keys from quantum layer 110. Classical data 127 may be communicated using IPsec, MACsec, OTNsec or any other protocol.

Data layer 125 may provide as many data channels as is necessary and/or desired.

Similarly, quantum layer 160 may include quantum key distribution device 162, service device 164, and key management system device 166. Quantum key distribution device 162 communicates quantum data, whereas service device 164 and key management system device 166 communicate classical data.

Quantum key distribution device 162 may send and receive quantum data from quantum key distribution device 112 over quantum channel 180. Quantum channel 180 may be, for example, a direct optical fiber between first quantum layer 110 and second quantum layer 160, a satellite link, etc.

Service device 164 may transmit and receive classical data to multiplexer/demultiplexer 130, and key management system device 116 may transmit and receive classical data from multiplexer/demultiplexer 130. These devices may be similar to service device 114 and key management system device 116, respectively.

Management layer 170 may include management device 172, which may be similar to management device 122.

Data layer 175 may be a source or destination for classical data 177.

Multiplexer/demultiplexer 130 and multiplexer/demultiplexer 150 may be any suitable devices capable of multiplexing and demultiplexing data. Multiplexer/demultiplexer 130 and multiplexer/demultiplexer 150 may be passive, dense wavelength-division multiplexing (DWDM) multiplexers.

Multiplexer/demultiplexer 130 and multiplexer/demultiplexer 150 multiplex (i.e., combine) the classical channels that are connected to their transmitting (Tx) ports and de-multiplex (i.e., separate) the classical channels that are connected to their receiving (Rx) ports.

Multiplexer/demultiplexer 130 may be provided with circulator 140, and multiplexer/demultiplexer 150 may be provided with circulator 145. A circulator is a non-reciprocal multiport device that routes signals from one port to the next, in a cyclic manner. For example, in a three-port circulator, a signal entering port 1 would exit from port 2, enter port 2 to exit from port 3, etc.

In one embodiment, circulators 140 and 145 may be three port circulators. Circulator 140 may receive data from multiplexer/demultiplexer 130 on port 1, and transmit the data to circulator 145 on channel 2, and may receive data from circulator 145 on channel 2 and transmit the data to multiplexer/demultiplexer. Circulator 145 may function in a similar manner.

Thus, as illustrated in FIG. 1, all classical communications take place over classical channel 185.

In one embodiment, an electronic device may include multiplexer/demultiplexer 130 and circulator 140. Data may be received at a transmitting input interface from, for example, quantum layer 110, management layer 120, and data layer 125, and provided to receiving ports of multiplexer/demultiplexer 130 for multiplexing, and a transmitting output interface that receives the output of port 2 of circulator 140 for transmission via a fiber. Similarly, a receiving input interface may receive data from a fiber and route it to port 2 of circulator 140, and a receiving output interface that outputs demultiplexed data from multiplexer/demultiplexer 130 to, for example, quantum layer 110, management layer 120, and data layer 125.

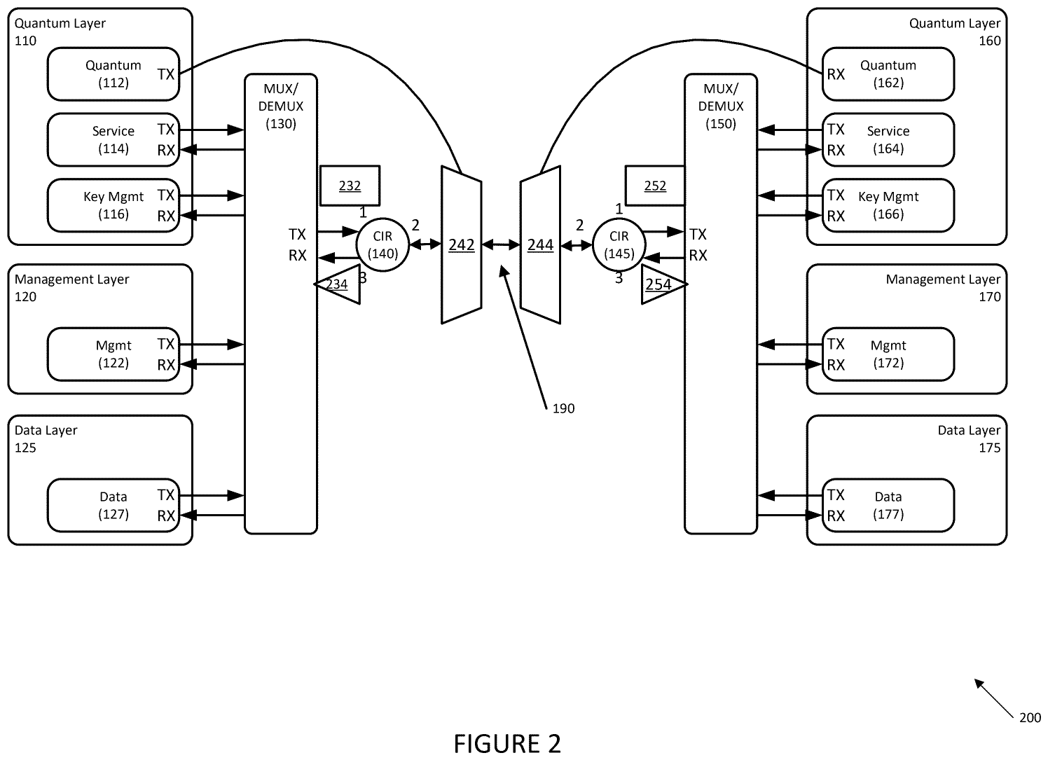

Referring to FIG. 2, a system for combining quantum and classical communication channels using optical technologies is disclosed according to an embodiment. In addition to elements in FIG. 1, FIG. 2 includes optical attenuators 232 and 252, and amplifiers 234 and 254. Optical attenuators 232 and 252 may reduce the aggregated power of the classical channels for coexistence with the quantum channel. Amplifiers 234 and 254, which may be Erbium-doped fiber amplifiers (EDFA), may be used to increase the power of the classical channels.

In one embodiment, amplifiers 234 and 254 are optional.

System 200 may also include filters 242 and 244. Filters 242 and 244 may be 100 GHz DWDM filters centered on a frequency of the quantum channel (e.g., Ch32).

Thus, quantum data and classical data can use single channel 190.

In one embodiment, an electronic device may include multiplexer/demultiplexer 130, optical attenuator 232, circulator 145, filter 242, and amplifier 234. Such a device may include input ports for quantum channels, service channels, key management channels, management switch channels, and data channels.

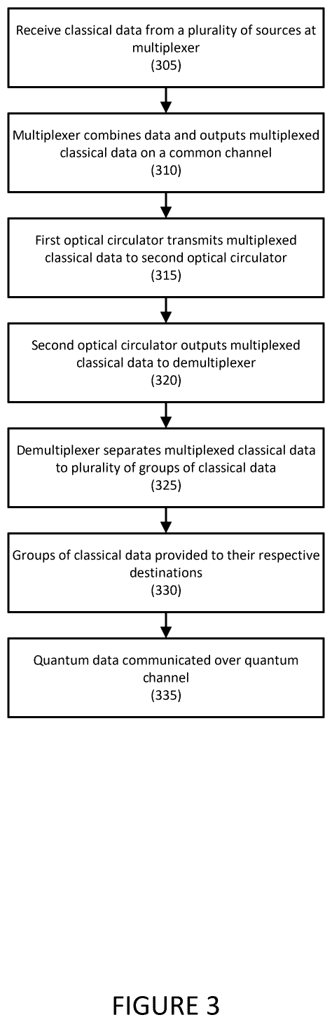

Referring to FIGS. 3, an exemplary method for combining quantum and classical communication channels using optical technologies is disclosed according to an embodiment.

In step 305, a multiplexer may receive classical data from a plurality of sources. For example, data from a service channel (e.g., channel 30), a KMS channel (e.g., channel 29), a management channel (e.g., channel 28), and a data channel (e.g., channel 27) may be received at a passive DWDM multiplexer/de-multiplexer.

In step 310, the multiplexer may combine the classical data and output the combined classical data (e.g., multiplexed classical data) on a common channel. The passive DWDM multiplexer/de-multiplexer works as a multiplexer and a de-multiplexer based on the transmission direction. It multiplexes (combines) the DWDM classical channels that are connected to its transmitting port and de-multiplexes (separates) the DWDM classical channels that are connected to its receiving port. The multiplexed classical data may be provided to a first optical circulator.

In step 315, an input of port 1 of the optical circulator is transmitted through port 2 and the input of port 2 is transmitted through port 3 (1→2 and 2→3). The optical circulator may combine the bi-directional classical traffic into a single fiber strand, instead of having two fiber strands, one for the transmitting port and one for the receiving port of the multiplexer. The first optical circulator may then transmit the multiplexed classical data over a single fiber to a second optical circulator.

In step 320, the second optical circulator passes the multiplexed classical data to a second multiplexer/demultiplexer. For example, port 2 of the second optical circulator is connected to the single fiber, and the traffic from port 2 is transmitted through port 3, which is connected to the common receiving port of the second demultiplexer.

In step 325, the second demultiplexer separates classical data to a plurality of groups of classical data. For example, the demultiplexer may separate all the classical channels into their individual channels (e.g., channel 30, channel 29, channel 28, and channel 27.

In step 330, the classical data may be provided to their respective destinations. For example, the individual channels may be connected to their corresponding SFP receiving ports.

In step 335, quantum data, such as quantum keys, may be communicated directly over a dedicated quantum communication channel.

The same methodology may be used for the counter propagation scheme, but in the counter-propagation scheme, the DWDM classical channels are transmitted in the opposite direction of the quantum channel.

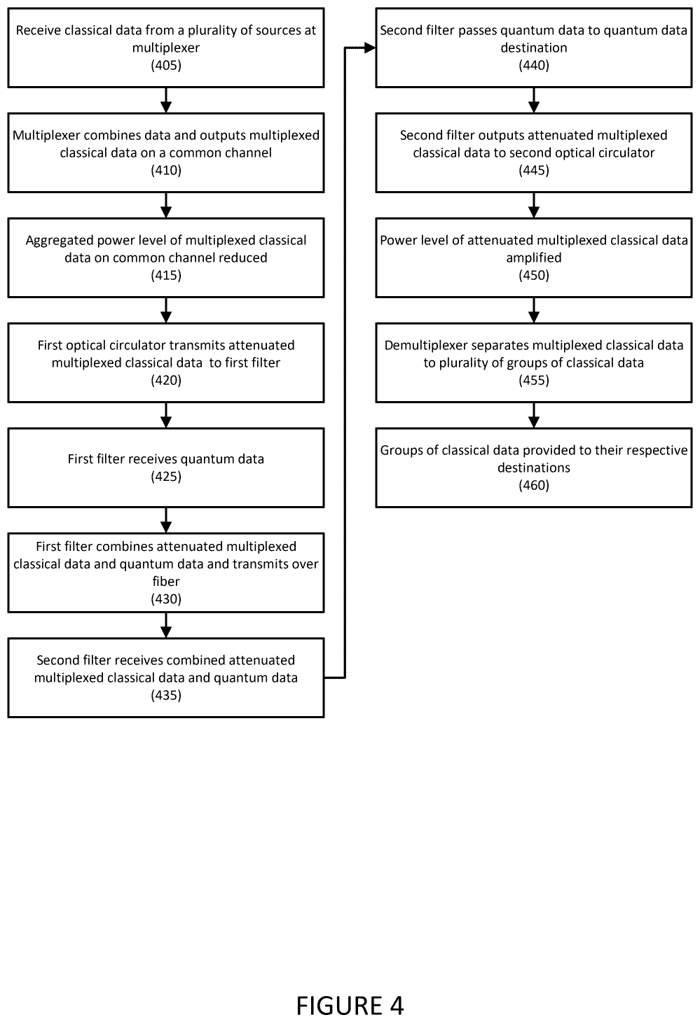

Referring to FIGS. 4, an exemplary method for combining quantum and classical communication channels using optical technologies is disclosed according to an embodiment.

In step 405, a multiplexer may receive classical data from a plurality of sources. For example, data from a service channel (e.g., channel 30), a KMS channel (e.g., channel 29), a management channel (e.g., channel 28), and a data channel (e.g., channel 27) may be received at a passive DWDM multiplexer/de-multiplexer.

In step 410, the multiplexer may combine the classical data and output the combined classical data (e.g., multiplexed classical data) on a common channel. The passive DWDM multiplexer/de-multiplexer works as a multiplexer and a de-multiplexer based on the transmission direction. It multiplexes (combines) the DWDM classical channels that are connected to its transmitting port and de-multiplexes (separates) the DWDM classical channels that are connected to its receiving port.

In a co-propagation configuration, the transmitting port of each classical channel small form-factor pluggable (SFP) transceivers is connected to the corresponding transmitting port of the multiplexer.

In step 415, the aggregated power level of the multiplexed classical data on the common channel may be reduced. For example, the common Tx port of the multiplexer may be connected to an optical attenuator to reduce the aggregated power of the multiplexed classical data for coexistence with the quantum data. The optical attenuator is then connected to an optical circulator.

In step 420, the multiplexed classical data received at an input of port 1 of the optical circulator is transmitted through port 2, and the input of port 2 is transmitted through port 3 (1→2 and 2→3). The optical circulator may combine the bi-directional classical traffic into a single fiber strand, instead of having two fiber strands, one for the transmitting port and one for the receiving port of the multiplexer.

In step 420, the first optical circulator transmits the attenuated multiplexed classical data to a first filter.

In step 425, the first filter receives quantum data.

In step 430, the first filter may combine the attenuated multiplexed classical data and quantum data and transmits over a single fiber. For example, after the attenuated multiplexed classical data is transmitted through port 2 of the first optical circulator, it coexists with the quantum channel using, for example, a 100 GHz DWDM filter centered at the quantum channel (e.g., Ch32). The quantum channel is connected to the pass port of Ch32 DWDM filter and the classical traffic from port 2 of the first optical circulator is connected to the reflect port. The quantum data is combined with the attenuated multiplexed classical data at the common port and transmitted through a single-mode fiber (SMF) spool in a coexistence configuration.

In step 435, a second filter receives the attenuated multiplexed classical data and quantum data. For example, after the transmission through the SMF spool, the quantum data and the attenuated multiplexed classical data are separated using a similar Ch32 100 GHz DWDM filter (Ch32 DWDM 2). The pass port only allows the quantum data to pass since it matches its wavelength (i.e., 1551.72 nm), while the attenuated multiplexed classical data is reflected to the reflect port.

In step 440, the second filter passes the quantum data to quantum data destination. For example, the quantum channel may be passed through a narrower 50 GHz Ch32 filter to further reduce the non-linear noise generated from the forward and backward Raman Scattering and before connecting it to the receiver.

In step 445, the second filter outputs classical data to a second optical circulator. For example, the reflect port of the Ch32 DWDM 2 filter which contains the classical channels traffic is then connected to port 2 of the second optical circulator. The traffic from port 2 is transmitted through port 3, which is connected to the common receiving port of demultiplexer.

In step 450, the power level of the attenuated multiplexed classical data may optionally be amplified. For example, port 3 of both optical circulators may only be connected to an EDFA in the active scenario.

In step 455, the demultiplexer separates the multiplexed classical data to plurality of groups of classical data. For example, the demultiplexer may separate all the classical data into their individual channels (e.g., channel 30, channel 29, channel 28, and channel 27.

In step 460, the classical data may be provided to their respective destinations. For example, the individual channels may be connected to their corresponding SFP receiving ports.

The same methodology may be used for the counter propagation scheme, but in the counter-propagation scheme, the DWDM classical channels are transmitted in the opposite direction of the quantum channel.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A system, comprising:
a first electronic device comprising a first multiplexer/demultiplexer and a first circulator, wherein the first electronic device receives service classical data from a first service device in a first quantum layer, key management system classical data from a first key management system device in the first quantum layer, and classical data from a classical data layer, the first multiplexer/demultiplexer multiplexes the service classical data, the key management system classical data, and the classical data into multiplexed classical data onto a common transmission channel, and the first circulator receives the multiplexed classical data from the common transmission channel at a first port and routes the multiplexed classical data to a fiber optic channel via a second port; and
a second electronic device comprising a second multiplexer/demultiplexer and a second circulator, wherein the second circulator receives the multiplexed classical data from the fiber optic channel on a second port, and routes the multiplexed classical data to the second multiplexer/demultiplexer on a third port, and the second multiplexer/demultiplexer demultiplexes the multiplexed classical data into the service classical data, the key management system classical data, and the classical data, and outputs the service classical data, the key management system classical data, and the classical data to a second quantum layer.

2. The system of claim 1, further comprising a quantum channel that receives quantum key distribution data from the first quantum layer and communicates the quantum key distribution data to the second quantum layer.

3. The system of claim 1, further comprising:
an optical attenuator that receives the multiplexed classical data, attenuates the multiplexed classical data, and outputs the attenuated multiplexed classical data to the first circulator, wherein the optical attenuator reduces an aggregated power of the multiplexed classical data.

4. The system of claim 3, further comprising:
an amplifier that receives the attenuated multiplexed classical data from the second circulator, amplifies the attenuated multiplexed classical data, and outputs the amplified multiplexed classical data to the second multiplexer/demultiplexer, wherein the amplifier increases the aggregated power of the multiplexed classical data.

5. The system of claim 4, wherein the amplifier comprises an Erbium-doped fiber amplifier.

6. The system of claim 3, further comprising a first filter and a second filter, the first filter receiving the attenuated multiplexed classical data and quantum key distribution data from the first quantum layer and passing the attenuated multiplexed classical data and the quantum key distribution data, and the second filter receiving the attenuated multiplexed classical data and the quantum key distribution data, filtering the quantum key distribution data, passing the filtered quantum key distribution data to the second quantum layer, and outputting the attenuated multiplexed classical data to the second circulator.

7. The system of claim 6, wherein the first filter and the second filter are centered on a frequency of a quantum channel.

8. A method, comprising:
receiving, at a first multiplexer/demultiplexer of a first electronic device, service classical data from a first quantum key distribution device service channel, key management system classical data from a first key management system, and classical data from a classical data layer in a first quantum layer;
multiplexing, by the first multiplexer/demultiplexer, the service classical data, the key management system classical data, and the classical data into multiplexed classical data on a common transmission channel;
receiving, by a first circulator, the multiplexed classical data from the common transmission channel at a first port of the first circulator;
routing, by the first circulator, the multiplexed classical data to a fiber optic channel via a second port of the first circulator;
receiving, by a second circulator, the multiplexed classical data from the fiber optic channel on a second port of the second circulator;
routing, by the second circulator, the multiplexed classical data to a third port of the second circulator;
receiving, by a second multiplexer/demultiplexer of a second electronic device, the multiplexed classical data from the third port of the second circulator and demultiplexing the multiplexed classical data into the service classical data, the key management system classical data, and the classical data; and
outputting, by the second multiplexer/demultiplexer, the service classical data, the key management system classical data, and the classical data to a second quantum layer.

9. The method of claim 8, further comprising:
receiving, on a quantum channel that receives quantum key distribution data from the first quantum layer; and
communicating, and communicates the quantum key distribution data to the second quantum layer.

10. The method of claim 8, further comprising:
receiving, by an optical attenuator, the multiplexed classical data from the first multiplexer/demultiplexer;
attenuating, by the optical attenuator, the multiplexed classical data, wherein the optical attenuator reduces an aggregated power of the multiplexed classical data; and
outputting, by the optical attenuator, the attenuated multiplexed classical data to the first port of the first circulator.

11. The method of claim 10, further comprising:
receiving, by an amplifier, the attenuated multiplexed classical data from the third port of the second circulator;
amplifying, by the amplifier, the attenuated multiplexed classical data, wherein the amplifier increases the aggregated power of the multiplexed classical data; and
outputting, by the amplifier, the amplified multiplexed classical data to the second multiplexer/demultiplexer.

12. The method of claim 11, wherein the amplifier comprises an Erbium-doped fiber amplifier.

13. The method of claim 10, further comprising:
receiving, at a first filter, the attenuated multiplexed classical data and quantum key distribution data from the first quantum layer;
passing, by the first filter, the attenuated multiplexed classical data and the quantum key distribution data to a second filter;
receiving, by the second filter, the attenuated multiplexed classical data and the quantum key distribution data;
filtering, by the second filter, the quantum key distribution data;
passing, by the second filter, the filtered quantum key distribution data to the second quantum layer; and
outputting, by the second filter, the attenuated multiplexed classical data to the second circulator.

14. The method of claim 13, wherein the first filter and the second filter are centered on a frequency of a quantum channel.

15. An electronic device, comprising:
a transmitting input interface that is configured to receive service classical data from a first quantum key distribution device service channel, key management system classical data from a first key management system, and classical data from a classical data layer in a first quantum layer;
a multiplexer/demultiplexer that is configured to multiplex the service classical data, the key management system classical data, and the classical data into multiplexed classical data on a common transmission channel;
a circulator that is configured to receive the multiplexed classical data from the common transmission channel at a first port of the circulator and output the multiplexed classical data on a second port of the circulator; and
an output interface that is configured to output the multiplexed classical data to a transmitting output interface.

16. The electronic device of claim 15, further comprising:
a receiving input interface that is configured to receive multiplexed classical data and to route the multiplexed classical data to the second port of the circulator; and
a receiving output interface that is configured to receive demultiplexed classical data from the multiplexer/demultiplexer and to output the demultiplexed classical data.

17. The electronic device of claim 15, further comprising:
an optical attenuator that is configured to receive the multiplexed classical data and to attenuate the multiplexed classical data and outputs the attenuated multiplexed classical data to the circulator, wherein the optical attenuator reduces an aggregated power of the multiplexed classical data.

18. The electronic device of claim 17, further comprising:
an amplifier that is configured to receive the attenuated multiplexed classical data from a second circulator, to amplify the attenuated multiplexed classical data, wherein the amplifier increases the aggregated power of the multiplexed classical data, and to output the amplified multiplexed classical data to a second multiplexer/demultiplexer.

19. The electronic device of claim 17, further comprising:
a filter that is configured to receive the attenuated multiplexed classical data and quantum key distribution data from the first quantum layer and to pass the attenuated multiplexed classical data and the quantum key distribution data to the receiving output interface.

20. The electronic device of claim 19, wherein the filter is further configured to receive multiplexed classical data and the quantum key distribution data, to filter the quantum key distribution data, to pass the filtered quantum key distribution data, and to output the attenuated multiplexed classical data to a second circulator.
